(19) United States
(12) Patent Application Publication
(10) Pub. No.: US 2021/0297238 A1
(43) Pub. Date: Sep. 23, 2021

(54) BLOCKCHAIN CONSENSUS METHOD AND SYSTEM, AND COMPUTER-READABLE STORAGE MEDIUM

(71) Applicant: Dora Network Limited, Hong Kong (HK)

(72) Inventor: Xiong Hui Guo, Hong Kong (HK)

(21) Appl. No.: 16/843,931

(22) Filed: Apr. 9, 2020

Related U.S. Application Data
(63) Continuation of application No. PCT/CN2020/080760, filed on Mar. 23, 2020.

(51) Int. Cl. H04L 9/06; H04L 12/18

(52) U.S. Cl. CPC H04L 9/0637; H04L 2209/38; H04L 12/18

(57) ABSTRACT

Provided are a blockchain consensus method and system, and a computer-readable storage medium, which are used for solving the technical problem that it takes a long time to execute a PBFT algorithm. The blockchain consensus method includes: an Nth proposer node initiating an Nth proposer request, so as to generate an Nth block and broadcast the Nth block according to the Nth proposer request, wherein the Nth block having a height of n, N and n being positive integers; an (N+1)th proposer node initiating an (N+1)th proposer request after receiving the Nth block, so as to generate an (N+1)th block and broadcast the (N+1)th block according to the (N+1)th proposer request, the (N+1)th block having a height of n+1; and after the Nth block ends a commit step, the (N+1)th block entering a commit step.

### CROSS REFERENCE TO RELATED APPLICATIONS

The present application is a Continuation Application of PCT Application No. PCT/CN2020/080760 filed on Mar. 23, 2020, the contents of which are incorporated herein by reference in their entirety.

### FIELD OF THE INVENTION

The present disclosure relates to the field of blockchain technology, and in particular, to a blockchain consensus method and system, and a computer-readable storage medium.

### BACKGROUND OF THE INVENTION

Blockchain is a new application model of computer technology such as distributed data storage, point-to-point transmission, consensus mechanism, and encryption algorithm. As core technology of blockchain, consensus mechanism refers to verification and confirmation of transactions in a short time by vote at special nodes in a blockchain network; for a transaction, if several nodes with irrelevant interests can reach a consensus, it can be considered that an entire network can reach a consensus on said transaction.

Consensus algorithm, which ensures data consistency between distributed nodes, can be divided into two categories, namely, probabilistic consistency algorithm and absolute consistency algorithm. Probabilistic consistency algorithm means that, for different distributed nodes, there is a great probability that data between nodes are consistent, but there is still a certain probability that data between some nodes are inconsistent. For a certain data node, the probability of data inconsistency between nodes will gradually decrease to close to zero over time, so that consistency is achieved eventually. For example, PoW (Proof of Work) algorithm, PoS (Proof of Stake) algorithm and DPoS (Delegated Proof of Stake) algorithm are all probabilistic consensus algorithms.

Absolute consistency algorithm means that at any point in time, data between different distributed nodes remain absolutely consistent, and there is no data inconsistency between different nodes. For example, PBFT (Practical Byzantine Fault Tolerance) algorithm is an absolute consistency algorithm.

PBFT algorithm is a consensus algorithm that is widely used in blockchain. It has the advantages of fast speed, high fault tolerance, and near zero bifurcations. When tested on an implementation version tendermint of PBFT algorithm, PBFT algorithm can reach a peak level of 1000 TPS (Transactions Per Second). This value is far ahead of algorithms such as PoW.

However, PBFT consensus algorithm still has the problem of long consensus time. Therefore, it is desirable to propose a new consensus algorithm that can significantly reduce a total consensus time.

### SUMMARY OF THE INVENTION

The present disclosure provides a blockchain consensus method and system, and a computer-readable storage medium, in order to solve the technical problem in the related technologies that it takes a long time to execute a PBFT algorithm.

In order to achieve the above object, according to a first aspect of the present disclosure, provided is a blockchain consensus method, including:

an Nth proposer node initiating an Nth proposer request, so as to generate an Nth block according to the Nth proposer request and broadcast the Nth block, wherein the Nth block has a height of n, N and n being positive integers;

an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and after the Nth block ends a commit step, the (N+1)th block entering a commit step.

With reference to the first aspect, in a first possible implementation of the first aspect, the (N+1)th proposer node initiating the (N+1)th proposer request after receiving the Nth block, so as to generate the (N+1)th block according to the (N+1)th proposer request and broadcast the (N+1)th block includes:

the Nth proposer node broadcasting the Nth block to validator nodes so that each of the validator nodes calculates according to the Nth block to confirm whether the validator nodes are the (N+1)th proposer node; and

when a validator node confirms by calculation that the validator node is the (N+1)th proposer node, removing transaction data in the Nth block, and generating the (N+1)th block with a height of n+1.

With reference to the first possible implementation of the first aspect, in a second possible implementation of the first aspect, the method further includes:

after the validator nodes satisfy a preset condition, conforming the Nth proposer node from the validator nodes.

With reference to the second possible implementation of the first aspect, in a third possible implementation of the first aspect, the validator nodes satisfying a preset condition includes:

the validator nodes waiting more than a time threshold or receiving transaction data.

With reference to the first possible implementation of the first aspect, in a fourth possible implementation of the first aspect, the method further includes:

after generating the Nth block according to the Nth proposer request and broadcasting the Nth block, the Nth block entering a consensus vote step; and

after confirming that the Nth block has received votes from more than ⅔ of the validator nodes, the Nth block entering a precommit step.

With reference to the fourth possible implementation of the first aspect, in a fifth possible implementation of the first aspect, the method further includes:

after the consensus vote step ends, when more than ⅔ of the validator nodes do not vote to confirm the Nth block, removing data of blocks having heights equal to n and higher than n, and re-initiating an Nth proposer request.

With reference to the fourth possible implementation of the first aspect, in a sixth possible implementation of the first aspect, the method further includes:

after the Nth proposer node initiates the Nth proposer request, when it times out for the Nth block during a propose step, removing data of blocks having heights equal to n and higher than n, and re-initiating an Nth proposer request.

With reference to the fourth possible implementation of the first aspect, in a seventh possible implementation of the first aspect, the method further includes:

after the Nth block enters a precommit step, the (N+1)th block entering a consensus vote step.

With reference to the fourth possible implementation of the first aspect, in an eighth possible implementation of the first aspect, the method further includes:

after the Nth block enters a commit step and more than ⅔ of the validator nodes vote to confirm the (N+1)th block, the (N+1)th block entering a precommit step.

With reference to the fourth possible implementation of the first aspect, in a ninth possible implementation of the first aspect, the method further includes:

before the Nth block enters the consensus vote step, determining whether heights of blocks that have been committed by the validator nodes that have received the Nth block are all less than the height of the Nth block; and

when the heights of blocks that have been committed by the validator nodes that have received the Nth block are all less than the height of the Nth block, the validator nodes that have received the Nth block performing a consensus vote on the Nth block.

With reference to the first aspect, in the tenth possible implementation of the first aspect, the method further includes:

after the Nth block ends the commit step, an (N+4)th block for which an (N+4)th proposer request is initiated by an (N+4)th proposer node enters a consensus vote step, wherein the (N+4)th proposer node generates the (N+4)th block and broadcasts the (N+4)th block when initiating the (N+4)th proposer request; and the (N+4)th block uses consensus data of the Nth block, and the (N+4)th block has a height of n+4.

With reference to the first aspect, in an eleventh possible implementation of the first aspect, the method further includes:

acquiring network attribute data of the blockchain; and

according to the network attribute data, adjusting the number of nodes that initiate a proposer request within a preset time period.

With reference to the eleventh possible implementation of the first aspect, in a twelfth possible implementation of the first aspect, the network attribute data includes average network bandwidth, block generation time, the number of transaction bytes, the number of transactions, the number of block bytes, the number of vote bytes, and the number of network nodes.

According to a second aspect of the embodiments of the present disclosure, provided is a blockchain consensus system, including:

nodes including a proposer node and a validator node; and

a controller configured to perform following steps:

an Nth proposer node initiating an Nth proposer request, so as to generate an Nth block according to the Nth proposer request and broadcast the Nth block, wherein the Nth block has a height of n, N and n being positive integers;

an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and

after the Nth block ends a commit step, the (N+1)th block entering a commit step.

With reference to the second aspect, in a first possible implementation of the second aspect, the (N+1)th proposer node initiating the (N+1)th proposer request after receiving the Nth block, so as to generate the (N+1)th block according to the (N+1)th proposer request and broadcast the (N+1)th block includes:

the Nth proposer node broadcasting the Nth block to validator nodes so that each of the validator nodes calculates according to the Nth block to conform whether the validator nodes are the (N+1)th proposer node; and

when a validator node confirms by calculation that the validator node is the (N+1)th proposer node, removing transaction data in the Nth block, and generating the (N+1)th block with a height of n+1.

With reference to the second aspect, in a second possible implementation of the second aspect, the controller is further configured to perform following steps:

after generating the Nth block according to the Nth proposer request and broadcasting the Nth block, the Nth block entering a consensus vote step; and

after confirming that the Nth block has received votes from more than ⅔ of the validator nodes, the Nth block entering a precommit step.

With reference to the second aspect, in a third possible implementation of the second aspect, the controller is further configured to perform following steps:

after generating the Nth block according to the Nth proposer request and broadcasting the Nth block, the Nth block entering a consensus vote step; and

after confirming that the Nth block has received votes from more than ⅔ of the validator nodes, the Nth block entering a precommit step.

With reference to the second aspect, in a fourth possible implementation of the second aspect, the controller is further configured to perform a following step:

after the consensus vote step ends, when the Nth block do not receive votes from more than ⅔ of the validator nodes, removing data of blocks having heights equal to n and higher than n, and re-initiating an Nth proposer request.

With reference to the second aspect, in a fifth possible implementation of the second aspect, the controller is further configured to perform a following step:

after the consensus vote step ends, when more than ⅔ of the validator nodes do not vote to confirm the Nth block, removing data of blocks having heights equal to n and higher than n, and re-initiating an Nth proposer request.

According to a third aspect of the embodiments of the present disclosure, provided is a computer-readable storage medium storing thereon instructions executable by a processor, the instructions, when executed, causing the processor to execute a blockchain consensus method, the method including following steps:

an Nth proposer node initiating an Nth proposer request, so as to generate an Nth block according to the Nth proposer request and broadcast the Nth block, wherein the Nth block has a height of n, N and n being positive integers;

an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and

after the Nth block ends a commit step, the (N+1)th block entering a commit step.

The above technical solutions can achieve at least following technical effects.

In the present disclosure, the steps of the PBFT algorithm are pipelined. That is, different from the PBFT algorithm that executes four steps serially in the related technologies, the present disclosure provides a PBFT algorithm that executes four steps in parallel, significantly reducing a total consensus time, thereby improving TPS, shortening block generation time, enhancing the scalability of a blockchain, solving the technical problem in the related technologies that it takes a long time to execute a PBFT algorithm.

Other features and advantages of the present disclosure will be described in detail in the embodiments below.

### BRIEF DESCRIPTION OF THE DRAWINGS

The drawings are used to provide a further understanding of the present disclosure, and constitute a part of the description. Together with the following embodiments, the drawings are used to explain the present disclosure, but do not constitute limitation to the present disclosure. In the drawings:

FIG. 1 is a flowchart of a blockchain consensus method according to an exemplary embodiment of the present disclosure.

FIG. 2 is a schematic diagram of a blockchain consensus method according to an exemplary embodiment of the present disclosure.

FIG. 3 is a time line comparison between executing a PBFT algorithm serially in the related technologies and executing a PBFT algorithm in parallel in the present disclosure.

FIG. 4 is a block diagram of a blockchain consensus system according to an exemplary embodiment of the present disclosure.

FIG. 5 is a block diagram of a proposer node device according to an exemplary embodiment of the present disclosure.

### DETAILED DESCRIPTION OF THE EMBODIMENTS

The embodiments of the present disclosure will be described in detail below with reference to the accompanying drawings and embodiments, so as to fully understand and implement the implementation process of how the present disclosure applies technical means to solve technical problems and achieve corresponding technical effects. The embodiments of the present application and various features in the embodiments can be combined with each other as long as there is no conflict, and the technical solutions formed are within the protection scope of the present disclosure.

It will be understood by those skilled in the art that the singular forms “a”, “an”, “the” and “said” used herein may include plural forms unless specifically stated. It should be further understood that the term “include” used in the description of the present disclosure refers to the presence of the described features, integers, steps, operations, elements and/or components, but does not exclude the presence or addition of one or more other features, integers, steps, operations, elements, components, and/or combinations thereof.

It will be understood by those skilled in the art that, unless otherwise defined, all terms (including technical and scientific terms) used herein have the same meanings as commonly understood by those of ordinary skill in the art to which the present disclosure belongs. It should also be understood that terms such as those defined in a general dictionary should be interpreted to have meanings consistent with those in the context of the existing technology, and unless specifically defined, they will not be interpreted with idealized or overly formal meanings.

At present, according to different application objects of blockchain, blockchain can be divided into three categories, namely public chain, private chain, and alliance chain. Public chain is completely decentralized, on which anyone can conduct transactions and read information. Anyone can participate in the transaction confirmation and consensus mechanism on the chain, and each node can join at any time, and can also exit at any time. Private chain is a blockchain system that is open to an individual or entity. The permissions of respective nodes in the system need to be allocated by an organization, and the amount of data opened to respective nodes is determined by the organization as the case may be. Alliance chain is controlled by multiple centers, and in the system, a common distributed ledger is used by several authoritative institutions. These nodes then coordinate their work according to a consensus mechanism.

Alliance chain is a partially decentralized blockchain on which the public can read information and conduct transactions, but validation of a transaction needs to be decided by the alliance itself. It should be noted that the consensus method provided by the present disclosure can be applied to other blockchain systems in addition to alliance chain.

In the related technologies, a PBFT algorithm includes:

1. a propose step of initiating a proposer request, i.e., broadcasting a new block;

2. a prevote step of waiting for more than ⅔ of nodes to conform receipt of the block;

3. a precommit step of waiting for more than ⅔ of the nodes to confirm that ⅔ of the nodes have voted to confirm the block; and

4. a commit step of committing the block and incorporating the block into a main chain.

In fact, each round of consensus relates to a (H, R, S) triplet, wherein H represents a block height (Height); R represents a round (Round), and S represents a step (Step) being performed.

The steps of implementation of the PBFT algorithm in the related technologies can be described as follows.

1. All validator nodes wait for a timeout at the height of a new block or receive a transaction, so as to enter a propose step.

2. After entering the propose step, a proposer node generates a block and broadcasts the block, and other validator nodes wait to receive the new block.

3. After the validator nodes receive the new block, if the new block is validated, it proceeds to a prevote step; each of the validator nodes votes and broadcasts the vote; and said new block waits to receive votes from more than ⅔ of the validator nodes.

4. After the new block receives votes from more than ⅔ of the validator nodes, if the votes are on the same new block, it proceeds to a precommit step. During the precommit step, it is necessary to confirm whether more than ⅔ of the validator nodes vote to confirm the new block.

5. After it is conformed in the precommit step that more than ⅔ of the validator nodes have voted to confirm the new block, the new block proceeds to a commit step in which the new block is committed and incorporated into a main chain, and then the new block proceeds to wait to start a consensus on a height with a next level.

The inventor of the present disclosure has discovered through research that the four steps required for the execution of the PBFT algorithm in the related technologies are serial, and due to network delay, it is necessary to wait for conformation from peer nodes. During the waiting period, resources will be idle, and there are still many difficulties to process short-term, high-intensity transaction requests.

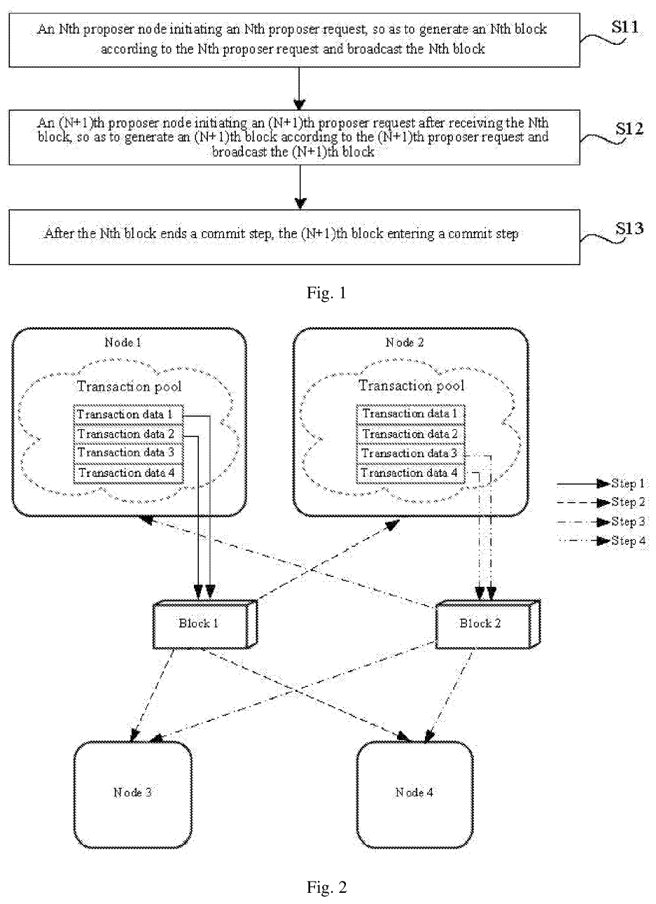

FIG. 1 is a flowchart of a blockchain consensus method according to an exemplary embodiment of the present disclosure, in order to solve the technical problem in the related technologies that it takes a long time to execute the PBFT algorithm. As shown in FIG. 1, the blockchain consensus method may include steps S11 to S13.

In step S11, an Nth proposer node initiates an Nth proposer request, so as to generate an Nth block according to the Nth proposer request and broadcast the Nth block, wherein the Nth block has a height of n, N and n being positive integers.

In step S12, an (N+1)th proposer node initiates an (N+1)th proposer request after receiving the Nth block, so as to generate an (N+1)th block according to the (N+1)th proposer request and broadcast the (N+1)th block, wherein the (N+1)th block has a height of n+1.

In step S13, after the Nth block ends a commit step, the (N+1)th block enters a commit step.

In step S11, the Nth proposer node may initiate the Nth proposer request after receiving an (N−1)th proposer request initiated by an (N−1)th proposer node; alternatively, the Nth proposer node is confirmed from validator nodes after the validator nodes satisfy a preset condition. The preset condition may be that the validator nodes wait for a timeout at the height of a new block or receive transaction data. When a certain validator node satisfies a preset condition, said validator node is confirmed as the Nth proposer node, and then it proceeds to a propose step in which the Nth proposer request is initiated.

After initiating the Nth proposer request, the Nth proposer node generates the Nth block according to the Nth proposer request and broadcasts the Nth block to the validator nodes, and the validator nodes determine whether transaction data in the Nth block are valid, and indicate whether the transaction data in the Nth block are valid by vote.

That is, after the Nth proposer node initiates the Nth proposer request, the Nth block will enter a consensus vote step. It should be noted that before entering the consensus vote step, it is necessary to determine whether the heights of blocks that have been committed by the validator nodes that have received the Nth block are all less than the height of the Nth block. When the heights of the committed blocks are all less than the height of the Nth block, the validator nodes that have received the Nth block performs a consensus vote on the Nth block.

In the consensus vote step, it is necessary to determine whether the Nth block has received votes from more than ⅔ of the validator nodes. If the Nth block has received votes from more than ⅔ of the validator nodes, the Nth block enters a precommit step. In the precommit step, it is necessary to confirm whether more than ⅔ of the validator nodes have voted to confirm the new block. If more than ⅔ of the validator nodes have voted to confirm the new block, the Nth block enters a commit step in which the Nth block is committed and incorporated into a main chain.

It should be noted that after the consensus vote step ends, if more than ⅔ of the validator nodes do not vote to confirm the Nth block, it is necessary to remove data of blocks having heights equal to n and higher than n and re-initiate an Nth proposer request; alternatively, in the precommit step, if not more than ⅔ of the validator nodes have voted to confirm the new block, it is necessary to remove data of blocks having heights equal to n and higher than n and re-initiate an Nth proposer request. In addition, after the Nth proposer node initiates the Nth proposer request, if it times out for the Nth block during the propose step, it is also necessary to remove data of blocks having heights equal to n and higher than n and re-initiate an Nth proposer request.

After the Nth proposer node generates the Nth block according to the Nth proposer request and broadcasts the Nth block to the validator nodes, the validator nodes calculate according to the Nth block to confirm whether they are the (N+1)th proposer node. That is, each validator node needs to calculate whether it is the (N+1)th proposer node that generates a block with a height of n+1.

After a certain validator node confirms, by calculation, that it is the (N+1)th proposer node, step S12 is performed. The (N+1)th proposer node initiates the (N+1)th proposer request after receiving the Nth block, so as to generate the (N+1)th block according to the (N+1)th proposer request and broadcast the (N+1)th block, wherein the (N+1)th block has a height of n+1.

The difference between the consensus algorithm of the present disclosure and the PBFT algorithm in the related technologies starts from step S12. In the present disclosure, the (N+1)th proposer node initiates the (N+1)th proposer request after receiving the Nth block. That is, in the present disclosure, when the Nth block enters a consensus vote step, the (N+1)th proposer node enters a propose step. However, in the related technologies, a next proposer node enters a propose step after a previous proposer node completes a commit step.

After initiating the (N+1)th proposer request, the (N+1)th proposer node generates the (N+1)th block according to the (N+1)th proposer request and broadcasts the (N+1)th block to the validator nodes, and the validator nodes determine whether transaction data in the (N+1)th block are valid, and indicate whether the transaction data in the (N+1)th block are valid by vote.

That is, after the (N+1)th proposer node initiates the (N+1)th proposer request, the (N+1)th block will enter a consensus vote step. It should be noted that before entering the consensus vote step, it is necessary to determine whether the heights of blocks that have been committed by the validator nodes that have received the (N+1)th block are all less than the height of the (N+1)th block. When the heights of the committed blocks are all less than the height of the (N+1)th block, the validator nodes that have received the Nth block perform a consensus vote on the (N+1)th block.

In the consensus vote step, it is necessary to determine whether the (N+1)th block has received votes from more than ⅔ of the validator nodes. If the (N+1)th block has received votes from more than ⅔ of the validator nodes, the (N+1)th block enters a precommit step. In the precommit step, it is necessary to confirm whether more than ⅔ of the validator nodes have voted to confirm the new block. If more than ⅔ of the Validator Nodes have Voted to Confirm the new block, the (N+1) block enters a commit step in which the (N+1) block is committed and incorporated into the main chain.

It should be noted that after the consensus vote step ends, if more than ⅔ of the validator nodes do not vote to confirm the (N+1)th block, it is necessary to remove data of blocks having heights equal to n+1 and higher than n+1; alternatively, in the precommit step, if not more than ⅔ of the validator nodes have voted to confirm the new block, it is necessary to remove data of blocks having heights equal to n+1 and higher than n+1 and re-initiate an (N+1)th proposer request. In addition, after the (N+1)th proposer node initiates the (N+1)th proposer request, if it times out for the (N+1)th block during the propose step, it is also necessary to remove data of blocks having heights equal to n+1 and higher than n+1 and re-initiate an (N+1) proposer request.

After the (N+1)th proposer node generates the (N+1)th block according to the (N+1)th proposer request and broadcasts the (N+1)th block to the validator nodes, the validator nodes calculate according to the (N+1)th block to conform whether they are an (N+2)th proposer node. That is, each validator node needs to calculate whether it is the (N+2)th proposer node that generates a block with a height of n+2. When the validator node confirms that it is the (N+2)th proposer node, transaction data in the (N+1)th block is removed, and an (N+2)th block with a height of n+2 is generated.

The (N+1)th block enters the consensus vote step after the Nth block enters the precommit step. The (N+1)th block enters the precommit step after the Nth block enters the commit step. The (N+1)th block enters the commit step after the Nth block is committed in the commit step.

In addition, after the Nth block ends the commit step, an (N+4)th proposer request initiated by an (N+4)th proposer node enters a consensus vote step, wherein the (N+4)th proposer node generates an (N+4)th block and broadcasts the (N+4)th block when initiating the (N+4)th proposer request; and the (N+4)th block uses consensus data of the Nth block, and the (N+4)th block has a height of n+4. For the (N+1)th block, after the (N+1)th block ends the commit step, an (N+5)th proposer node initiates an (N+5)th proposer request and enters a consensus vote step, so as to generate an (N+5)th block according to the (N+5)th proposer request and broadcast the (N+5)th block, wherein the (N+5)th block uses consensus data of the (N+1)th block, and the (N+5)th block has a height of n+5.

Time required to initiate a proposer request is very short, but due to the influence of factors such as bandwidth and block generation speed, it is necessary to control the number of pipeline stages, i.e., “degree of parallelism”, which is the number of nodes that initiate a proposer request within a preset time period. The number of pipeline stages can be controlled by acquiring network attribute data of a blockchain and then adjusting, according to the network attribute data, the number of nodes that initiate a proposer request within a preset time period.

The network attribute data may include average network bandwidth, block generation time, the number of transaction bytes, the number of transactions, the number of block bytes, the number of vote bytes, and the number of network nodes. Therefore, in order to achieve the highest TPS, it is necessary to continuously adjust the degree of parallelism according to the above factors, observe the results, and find the best balance point.

The blockchain consensus method of the present disclosure will be described below using a complete example. Steps are described as follows.

1. After all validator nodes wait for a timeout at the height of a new block or receive transaction data, an Nth proposer node is conformed from the validator nodes, so as to enter a propose step.

2. After entering the propose step, the Nth proposer node generates a block. Here a validator node height n needs to be added into the header of the block, i.e., block height data is added. After the height data is added, the block is broadcast, and other validator nodes wait to receive the block.

3. After the validator nodes receive the block with a height of n, if the block is validated, it proceeds to a prevote step, and after the block is voted on and broadcasted, the block waits to receive notes from more than ⅔ of the validator nodes; at the same time, after receiving the block with the height of n, the validator nodes enter a WaitToPropose step. If the block with the height of n has entered a prevote step, each validator node calculates whether it is an (N+1)th proposer node that generates a block with a height of n+1. If so, the validator node generates an (N+1)th block. Here, it is necessary to remove transaction data in the block with the height of n. At the same time, a validator node height n+1 needs to be added into the header of the block, and other validator nodes with a height of n+1 wait to receive the block with the height of n+1.

It should be noted that if the propose step waits for a timeout, it is necessary to wait for a failure of the consensus and then roll back to clear all consensuses on heights of higher levels.

4. At this time, the pipeline starts to work, and several blocks are in consensus at the same time. After the validator nodes receive the block with the height n+1, if the block with the height of n is still in consensus at this time, the block with the height of n+1 enters a WaitToPrevote step. If the block with the height of n has completed the prevote step at this time, the block with the height of n+1 directly enters the prevote step; otherwise, the block with the height of n+1 will be waiting until the block with the height of n completes the prevote step.

5. After the block with the height of n receives notes from more than ⅔ of the validator nodes, if the votes are on the same block, the block proceeds to a precommit step. At this time, the block with the height of n+1 is notified to enter a prevote step. The block with the height of n+1 enters the prevote step, and after the block with the height of n+1 is voted on and broadcasted, the block with the height of n+1 waits to receive votes from more than ⅔ of the validator nodes. After receiving the votes from more than ⅔ of the validator nodes, the block with the height of n+1 enters a precommit step. If the block with the height of n has completed a precommit step, the block with the height of n+1 directly enters the precommit step; otherwise, the block with the height of n+1 will be waiting until the block with the height of n completes the precommit step.

6. The block with the height of n enters a commit step after completing the precommit step in which the block with the height of n is confirmed by more than ⅔ of the validator nodes by vote. At this time, the block with the height of n+1 is notified to enter a precommit step. The block with the height of n+1 enters the precommit step. After the block with the height of n+1 completes the precommited step in which the block with the height of n+1 waits to be committed and broadcasted and then waits to be confirmed by ⅔ of the validator nodes by vote, if the block with the height of n has completed the commit step, the block with the height of n+1 directly enters a commit step; otherwise, the block with the height of n+1 will be waiting until the block with the height of n completes the commit step.

7. After the block with the height of n completes the commit step, it proceeds to the consensus on height n+4, namely, an (N+4)th proposer request is initiated by an (N+4)th proposer node to generate an (N+4)th block and broadcast the (N+4)th block. At this time, the block with the height of n+1 is notified to enter the commit step. The block with the height of n+1 enters the commit step, and after the block with the height of n+1 completes the commit step, it proceeds to the consensus on height n+5, namely, an (N+5)th proposer request is initiated by an (N+5)th proposer node to generate an (N+5)th block and broadcast the (N+5)th block.

Next, four nodes are taken as an example for description. Please refer to FIG. 2. FIG. 2 is a schematic diagram of a blockchain consensus method according to an exemplary embodiment of the present disclosure. As shown in FIG. 2, the blockchain consensus method may include following steps.

In step 1, node 1, which serves as a first proposer node, initiates a first proposer request. Node 1 extracts transaction data 1 and transaction data 2, which serve as transaction data, from a transaction pool so as to generate block 1 with a height of 1.

In step 2, node 1 broadcasts block 1 with the height of 1 to node 2, node 3, and node 4.

In step 3, after receiving block 1 with the height of 1, node 2 performs calculations to confirm whether node 2 is a second proposer node. After node 2 conforms by calculation that it is the second proposer node, transaction data 1 and transaction data 2 in block 1 are removed and a second proposer request is initiated. Node 2 extracts transaction data 3 and transaction data 4, which serve as transaction data, from a transaction pool so as to generate block 2 with a height of 2.

In step 4, node 2 broadcasts block 2 with the height of 2 to node 1, node 3, and node 4.

After node 1 broadcasts block 1 with the height of 1 to node 2, node 3, and node 4, block 1 enters a prevote step. After receiving votes from at least two nodes of node 2, node 3, and node 4, block 1 enters a precommit step. Next, block 2 enters a prevote step. After block 1 completes the precommit step and enters a commit step, block 2 needs to receive votes from at least two nodes of node 1, node 3, and node 4 so as to enter a precommit step. Finally, after block 1 completes the commit step and is incorporated into a main chain, block 2 enters a commit step.

It should be noted as follows.

1. The proposer node needs to be changed every round, and when the block with the height of n+1 is generated, validator nodes of the block with the height of n+1 are not determined yet. Therefore, the proposer node of the block with the height of n+1 should be calculated based on the validator nodes with a height of n. Therefore, it is necessary to add information of a validator node height (namely, a block height) into the header of the block. After receiving said information, other validator nodes can determine whether the proposer node is valid according to the validator nodes of this height.

2. Commit data and evidence data need to be added into each block. When a consensus is not reached on a previous block, these data are not generated. For the pipeline, the first four blocks do not include these data until the fifth block is generated. The fifth block uses consensus data of the first block, the sixth block uses consensus data of the second block, and so on.

3. If no consensus is reached on a block with a height of n, it proceeds to a new round of consensus on the block with a height of n. At the same time, all consensuses on heights greater than n being performed must be cleared.

4. After adding the design of the pipeline, the calculation of the validity of a proposer request is determined by validator nodes related to a validator node height (namely, a block height) in the header of the block. Thus, it is possible that Byzantine nodes will generate new blocks with a previous validator node height, causing the validator nodes to fail to confirm which proposer node is correct. Therefore, it is necessary to add the determination that the heights of the validator nodes must be greater than the heights of the blocks that have been committed locally, so that a Byzantine node will not get more than ⅔ of votes, and at the same time, local nodes that have not reached the new height must also vote when they receive blocks that are higher than the validator node height (even if they have already voted for Byzantine nodes first) so as to ensure that valid blocks can get votes from more than ⅔ of the validator nodes.

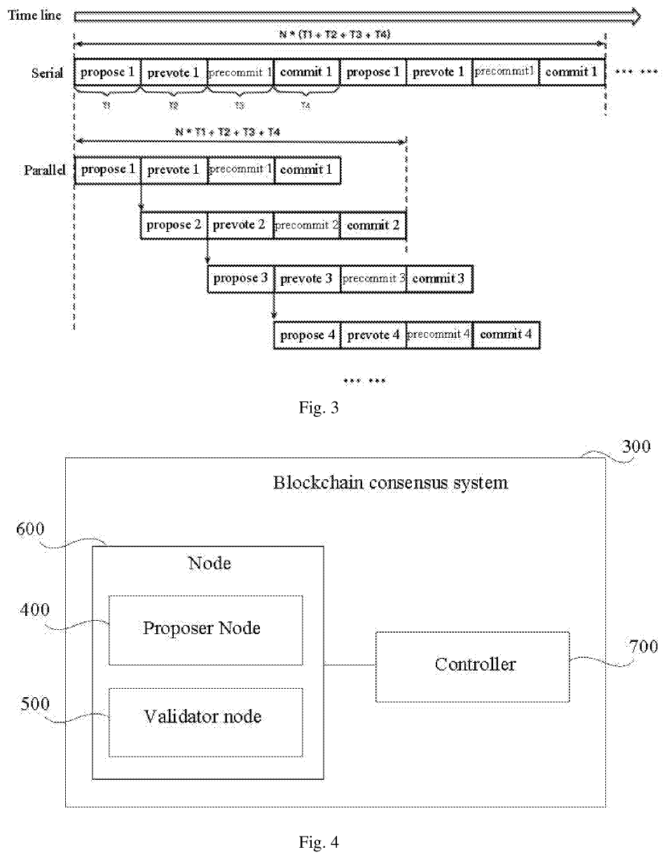

Referring to FIG. 3, FIG. 3 is a time line comparison between executing a PBFT algorithm serially in the related technologies and executing a PBFT algorithm in parallel in the present disclosure. As shown in FIG. 3, assuming that durations of four steps are T1, T2, T3, and T4, when executing the four steps of the PBFT algorithm serially in the related technologies, the time required to generate N blocks is N*(T1+T2+T3+T4); and when executing the four steps of the PBFT algorithm in parallel in the present disclosure, the time required to generate N blocks is only N*T1+T2+T3+T4, which significantly reduces a block generation time.

In the present disclosure, the steps of the PBFT algorithm are pipelined. That is, different from the PBFT algorithm that executes four steps serially in the related technologies, the present disclosure provides a PBFT algorithm that executes four steps in parallel, significantly reducing a total consensus time, thereby improving TPS, shortening block generation time, enhancing the scalability of a blockchain, solving the technical problem in the related technologies that it takes a long time to execute a PBFT algorithm.

It is noteworthy that, for the method embodiment shown in FIG. 1, for simplicity of description, the method is expressed as a combination of a series of actions, but those skilled in the art should understand that the present disclosure is not limited by the described action sequence. In addition, those skilled in the art should also understand that the embodiments described in the description are all preferred embodiments, and the actions involved are not necessarily required by the present disclosure.

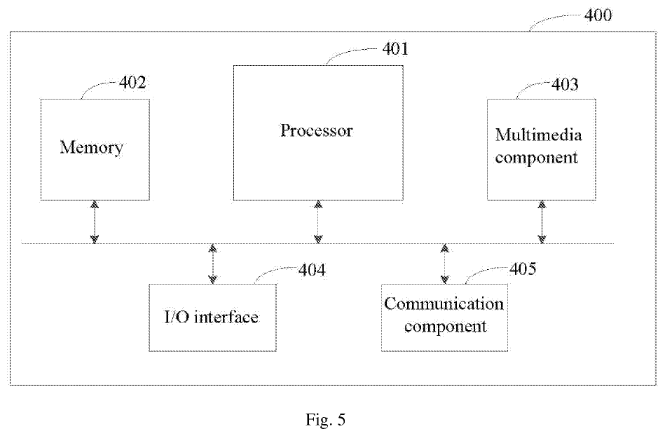

FIG. 4 is a block diagram of a blockchain consensus system according to an exemplary embodiment of the present disclosure, in order to solve the technical problem in related technologies that it takes a long time to execute a PBFT algorithm. As shown in FIG. 4, a blockchain consensus system 300 includes a node 600 and a controller 700.

The node 600 includes a proposer node 400 and a validator node 500.

The controller 700 is configured to perform following steps.

An Nth proposer node initiates an Nth proposer request, so as to generate an Nth block according to the Nth proposer request and broadcast the Nth block, wherein the Nth block has a height of n, N and n being positive integers.

The (N+1)th proposer node initiates an (N+1)th proposer request after receiving the Nth block, so as to generate an (N+1)th block according to the (N+1)th proposer request and broadcast the (N+1)th block, wherein the (N+1)th block has a height of n+1.

After the Nth block ends a commit step, the (N+1)th block enters a commit step.

It should be noted that there may be multiple proposer nodes 400 and validator nodes 500, and both the Nth proposer node and the (N+1)th proposer node are proposer nodes 400.

Optionally, the (N+1)th proposer node initiating the (N+1)th proposer request after receiving the Nth block, so as to generate the (N+1)th block according to the (N+1)th proposer request and broadcast the (N+1)th block includes:

the Nth proposer node broadcasting the Nth block to validator nodes, so that each of the validator nodes calculates according to the Nth block to confirm whether the validator nodes are the (N+1)th proposer node; and

when a validator node confirms by calculation that the validator node is the (N+1)th proposer node, removing transaction data in the Nth block, and generating the (N+1)th block with a height of n+1.

Optionally, the controller 700 is further configured to perform a following step: after the validator nodes satisfy a preset condition, confirming the Nth proposer node from the validator nodes.

Optionally, the validator nodes satisfying a preset condition includes: the validator nodes waiting more than a time threshold or receiving transaction data.

Optionally, the controller 700 is further configured to perform following steps:

after generating the Nth block according to the Nth proposer request and broadcasting the Nth block, the Nth block entering a consensus vote step; and

after confirming that the Nth block has received votes from more than ⅔ of the validator nodes, the Nth block entering a precommit step.

Optionally, the controller 700 is further configured to perform a following step: after the consensus vote step ends, when more than ⅔ of the validator nodes have not voted to confirm the Nth block, removing data of blocks having heights equal to n and higher than n, and re-initiating an Nth proposer request.

Optionally, the controller 700 is further configured to perform a following step: after the Nth proposer node initiates the Nth proposer request, when it times out for the Nth block during a propose step, removing data of blocks having heights equal to n and higher than n, and re-initiating an Nth proposer request.

Optionally, the controller 700 is further configured to perform a following step: after the Nth block enters the precommit step, the (N+1)th block entering a consensus vote step.

Optionally, the controller 700 is further configured to perform a following step: after the Nth block enters a commit step and more than ⅔ of the validator nodes vote to confirm the (N+1)th block, the (N+1)th block entering a precommit step.

Optionally, the controller 700 is further configured to perform following steps:

before the Nth block enters the consensus vote step, determining whether heights of blocks that have been committed by the validator nodes that have received the Nth block are all less than the height of the Nth block; and

when the heights of blocks that have been committed by the validator nodes that have received the Nth block are all less than the height of the Nth block, the validator nodes that have received the Nth block performing a consensus vote on the Nth block.

Optionally, the controller 700 is further configured to perform a following step:

after the Nth block ends the commit step, an (N+4)th block for which an (N+4)th proposer request is initiated by an (N+4)th proposer node enters a consensus vote step, wherein the (N+4)th proposer node generates the (N+4)th block and broadcasts the (N+4)th block when initiating the (N+4)th proposer request; and the (N+4)th block uses consensus data of the Nth block, and the (N+4)th block has a height of n+4.

Optionally, the controller 700 is further configured to perform following steps:

acquiring network attribute data of the blockchain; and

according to the network attribute data, adjusting the number of nodes that initiate a proposer request within a preset time period.

Optionally, the network attribute data includes average network bandwidth, block generation time, the number of transaction bytes, the number of transactions, the number of block bytes, the number of voting bytes, and the number of network nodes.

The controller 700 may be an integrated circuit chip and has information processing capabilities. The controller 700 may be a general-purpose processor, including a central processing unit (CPU), a network processor (NP), and the like.

Regarding the blockchain consensus system in the embodiments mentioned above, the specific manners in which respective modules perform operations have been described in detail in the embodiments of the method, and will not be explained in detail here.

FIG. 5 is a block diagram of a proposer node device according to an exemplary embodiment of the present disclosure. As shown in FIG. 5, a proposer node 400 may include a processor 401, a memory 402, a multimedia component 403, an input/output (I/O) interface 404, and a communication component 405.

The processor 401 is used for controlling the overall operation of the proposer node 400 so as to complete all or part of the steps in the blockchain consensus method mentioned above. The memory 402 is used for storing various types of data so as to support the operations at the proposer node 400. The data may include, for example, instructions for any application program or method for operating at the proposer node 400, and application-related data. The memory 402 may be implemented by any type of volatile or non-volatile storage devices or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk. The multimedia component 403 may include a screen and an audio component. The screen may be, for example, a touch screen, and the audio component is used for outputting and/or inputting audio signals. For example, the audio component may include a microphone for receiving external audio signals. The received audio signals may be further stored in the memory 402 or transmitted through the communication component 405. The audio component also includes at least one speaker for outputting audio signals. The I/O interface 404 provides an interface between the processor 401 and other interface modules. Other interface modules may be a keyboard, a mouse, a button, and the like. These buttons may be virtual buttons or physical buttons. The communication component 405 is used for wired or wireless communication between the device 400 and other devices. Wireless communication may be, for example, wi-fi, bluetooth, near field communication (NFC), 2G, 3G, or 4G, or a combination of one or more thereof. Therefore, the corresponding communication component 405 may include a wi-fi module, a bluetooth module, and an NFC module.

In an exemplary embodiment, the proposer node 400 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components, for implementing the blockchain consensus method mentioned above.

In another exemplary embodiment, further provided is a computer-readable storage medium including instructions. The computer-readable storage medium stores thereon instructions executable by a processor, and the instructions, when executed, cause the processor to execute a blockchain consensus method, the method including following steps:

an Nth proposer node initiating an Nth proposer request, so as to generate an Nth block according to the Nth proposer request and broadcast the Nth block, wherein the Nth block has a height of n, N and n being positive integers;

an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and

after the Nth block ends a commit step, the (N+1)th block entering a commit step.

For a method implemented when a computer program running on the processor is executed, reference may be made to the embodiments of the blockchain consensus method of the present disclosure, and details are not described herein again.

The processor may be an integrated circuit chip, and has information processing capabilities. The processor may be a general-purpose processor, including a central processing unit (CPU), a network processor (NP), and the like.

The preferred embodiments of the present disclosure have been described in detail above with reference to the accompanying drawings; however, the present disclosure is not limited to the specific details in the embodiments mentioned above. Within the scope of the technical concept of the present disclosure, various simple modifications can be made to the technical solutions of the present disclosure, and these simple modifications all belong to the protection scope of the present disclosure.

In addition, it should be noted that the specific technical features described in the embodiments mentioned above may be combined in any suitable manner as long as there is no conflict. In order to avoid unnecessary repetition, various possible combinations are not described herein again.

In addition, various embodiments of the present disclosure may also be combined in any way without deviating from the idea of the present disclosure, and these combinations should also be regarded as the contents disclosed in the present disclosure.

1. A blockchain consensus method, comprising:
an Nth proposer node initiating an Nth proposer request, so as to generate an Nth block according to the Nth proposer request and broadcast the Nth block, wherein the Nth block has a height of n, N and n being positive integers;
an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and
after the Nth block ends a commit step, the (N+1)th block entering a commit step.

2. The method according to claim 1, wherein the (N+1)th proposer node initiating the (N+1)th proposer request after receiving the Nth block, so as to generate the (N+1)th block according to the (N+1)th proposer request and broadcast the (N+1)th block comprises:
the Nth proposer node broadcasting the Nth block to validator nodes so that each of the validator nodes calculates according to the Nth block to confirm whether the validator nodes are the (N+1)th proposer node; and
when a validator node confirms by calculation that the validator node is the (N+1)th proposer node, removing transaction data in the Nth block, and generating the (N+1)th block with a height of n+1.

3. The method according to claim 2, further comprising:
after the validator nodes satisfy a preset condition, conforming the Nth proposer node from the validator nodes.

4. The method according to claim 3, wherein the validator nodes satisfying a preset condition comprises:
the validator nodes waiting more than a time threshold or receiving transaction data.

5. The method according to claim 2, further comprising:
after generating the Nth block according to the Nth proposer request and broadcasting the Nth block, the Nth block entering a consensus vote step; and
after confirming that the Nth block has received votes from more than ⅔ of the validator nodes, the Nth block entering a precommit step.

6. The method according to claim 5, further comprising:
after the consensus vote step ends, when more than ⅔ of the validator nodes do not vote to confirm the Nth block, removing data of blocks having heights equal to n and higher than n, and re-initiating an Nth proposer request.

7. The method according to claim 5, further comprising:
after the Nth proposer node initiates the Nth proposer request, when it times out for the Nth block during a propose step, removing data of blocks having heights equal to n and higher than n, and re-initiating an Nth proposer request.

8. The method according to claim 5, further comprising:
after the Nth block enters a precommit step, the (N+1)th block entering a consensus vote step.

9. The method according to claim 5, further comprising:
after the Nth block enters a commit step and more than ⅔ of the validator nodes vote to confirm the (N+1)th block, the (N+1)th block entering a precommit step.

10. The method according to claim 5, further comprising:
before the Nth block enters the consensus vote step, determining whether heights of blocks that have been committed by the validator nodes that have received the Nth block are all less than the height of the Nth block; and
when the heights of blocks that have been committed by the validator nodes that have received the Nth block are all less than the height of the Nth block, the validator nodes that have received the Nth block performing a consensus vote on the Nth block.

11. The method according to claim 1, further comprising:
after the Nth block ends the commit step, an (N+4)th block for which an (N+4)th proposer request is initiated by an (N+4)th proposer node enters a consensus vote step, wherein the (N+4)th proposer node generates the (N+4)th block and broadcasts the (N+4)th block when initiating the (N+4)th proposer request; and the (N+4)th block uses consensus data of the Nth block, and the (N+4)th block has a height of n+4.

12. The method according to claim 1, further comprising:
acquiring network attribute data of the blockchain; and
according to the network attribute data, adjusting the number of nodes that initiate a proposer request within a preset time period.

13. The method according to claim 12, wherein the network attribute data comprises average network bandwidth, block generation time, the number of transaction bytes, the number of transactions, the number of block bytes, the number of vote bytes, and the number of network nodes.

14. A blockchain consensus system, comprising:
nodes including a proposer node and a validator node; and
a controller configured to perform following steps:
an Nth proposer node initiating an Nth proposer request, so as to generate an Nth block according to the Nth proposer request and broadcast the Nth block, wherein the Nth block has a height of n, N and n being positive integers;
an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and
after the Nth block ends a commit step, the (N+1)th block entering a commit step.

15. The blockchain consensus system according to claim 14, wherein the (N+1)th proposer node initiating the (N+1)th proposer request after receiving the Nth block, so as to generate the (N+1)th block according to the (N+1)th proposer request and broadcast the (N+1)th block comprises:
the Nth proposer node broadcasting the Nth block to validator nodes so that each of the validator nodes calculates according to the Nth block to conform whether the validator nodes are the (N+1)th proposer node; and
when a validator node confirms by calculation that the validator node is the (N+1)th proposer node, removing transaction data in the Nth block, and generating the (N+1)th block with a height of n+1.

16. The blockchain consensus system according to claim 14, wherein the controller is further configured to perform following steps:
after generating the Nth block according to the Nth proposer request and broadcasting the Nth block, the Nth block entering a consensus vote step; and
after confirming that the Nth block has received votes from more than ⅔ of the validator nodes, the Nth block entering a precommit step.

17. The blockchain consensus system according to claim 15, wherein the controller is further configured to perform following steps:
after generating the Nth block according to the Nth proposer request and broadcasting the Nth block, the Nth block entering a consensus vote step; and
after confirming that the Nth block has received votes from more than ⅔ of the validator nodes, the Nth block entering a precommit step.

18. The blockchain consensus system according to claim 16, wherein the controller is further configured to perform a following step:
after the consensus vote step ends, when the Nth block do not receive votes from more than ⅔ of the validator nodes, removing data of blocks having heights equal to n and higher than n, and re-initiating an Nth proposer request.

19. The blockchain consensus system according to claim 17, wherein the controller is further configured to perform a following step:
after the consensus vote step ends, when more than ⅔ of the validator nodes do not vote to confirm the Nth block, removing data of blocks having heights equal to n and higher than n, and re-initiating an Nth proposer request.

20. A computer-readable storage medium storing thereon instructions executable by a processor, the instructions, when executed, causing the processor to execute a blockchain consensus method, the method comprising following steps:
an Nth proposer node initiating an Nth proposer request, so as to generate an Nth block according to the Nth proposer request and broadcast the Nth block, wherein the Nth block has a height of n, N and n being positive integers;
an (N+1)th proposer node initiating an (N+1)th proposer request after receiving the Nth block, so as to generate an (N+1)th block according to the (N+1)th proposer request and broadcast the (N+1)th block, wherein the (N+1)th block has a height of n+1; and
after the Nth block ends a commit step, the (N+1)th block entering a commit step.
